(19) United States
(12) Patent Application Publication
(10) Pub. No.: US 2024/0040497 A1
(43) Pub. Date: Feb. 1, 2024

(54) USE MANAGEMENT APPARATUS, USE MANAGEMENT SYSTEM, METHOD, AND NON-TRANSITORY COMPUTER READABLE MEDIUM

(71) Applicant: NEC Corporation, Minato-ku, Tokyo (JP)

(72) Inventor: Tadayuki OHNO, Tokyo (JP)

(73) Assignee: NEC Corporation, Minato-ku, Tokyo (JP)

(21) Appl. No.: 18/266,035

(22) PCT Filed: Dec. 14, 2020
(86) PCT No.: PCT/JP2020/046528

§ 371 Date: Jun. 8, 2023

(51) Int. Cl. H04W 48/18

(52) U.S. Cl. CPC H04W 48/18

(57) ABSTRACT

A use management apparatus (11) according to the present disclosure includes: an acquisition means (111) for acquiring, from a user, a type of a service desired by the user using a terminal (12) and a scheduled use time of the service, and acquiring a use condition of an application to be used when receiving the service, and a request condition for a communication carrier when receiving the service; and a connection destination determination means (112) for selecting a predetermined communication carrier satisfying the use condition and the request condition, extracting a predetermined slice being available at the scheduled use time from among the predetermined communication carriers, and determining a connection destination communication carrier and a connection destination slice, based on a routing parameter.

### TECHNICAL FIELD

The present disclosure relates to a use management apparatus, a use management system, a method, and a non-transitory computer readable medium, and more particularly, to a use management apparatus, a use management system, a method, and a non-transitory computer readable medium that are capable of selecting an optimum connection destination communication carrier and an optimum connection destination slice, based on a request condition for a communication carrier, a use condition of an application, and the like.

### BACKGROUND ART

In recent years, as a wireless business operator that provides a wireless connection service for a wireless terminal, a large number of wireless business operators exist for each country or region. Among them, it is desired to select an optimum wireless business operator in consideration of a request of a user using a wireless terminal, and connect the wireless terminal to the optimum wireless business operator. Note that, a wireless terminal may also be referred to as a terminal. In addition, a wireless business operator may be referred to as a communication carrier.

Patent Literature 1 discloses that, when a use operation is performed by a user, a connection request to an application service server is transmitted from a wireless terminal apparatus to the application service server via a first wireless business operator. In addition, Patent Literature 1 discloses that, when the application service server receives the connection request, the application service server searches for a wireless business operator being connectable by the wireless terminal apparatus, based on location information included in the received connection request. In addition, Patent Literature 1 discloses that the application service server selects, from among the extracted wireless business operators, an optimum wireless business operator when the wireless terminal apparatus uses an application service related to the connection request.

### CITATION LIST

### Patent Literature

[Patent Literature 1] Japanese Unexamined Patent Application Publication No. 2012-105076

### SUMMARY OF INVENTION

### Technical Problem

As described above, it is disclosed that an application service server that receives a connection request from a wireless terminal apparatus (terminal) selects an optimum wireless business operator (communication carrier) when an application service is provided for the terminal, based on a content of the application service and a terminal location. However, it is not disclosed to select an optimum radio operator for providing the application service, for example, in consideration of a communication cost of a wireless business operator, a key performance indicator (KPI), and the like. Therefore, there is a problem that it is desirable to select an optimum radio operator in consideration of the communication cost of the wireless business operator, the KPI, and the like.

An object of the present disclosure is to provide a use management apparatus, a use management system, a method, and a non-transitory computer readable medium that solve the problem described above.

### Solution to Problem

A use management apparatus according to the present disclosure includes:
an acquisition means for acquiring, from a user, a type of a service desired by the user using a terminal and a scheduled use time of the service, and acquiring a use condition of an application to be used when receiving the service, and a request condition for a communication carrier when receiving the service;
a connection destination determination means for selecting a predetermined communication carrier satisfying the use condition and the request condition from among a plurality of communication carriers, extracting a predetermined slice being available at the scheduled use time from among the predetermined communication carriers, and determining a connection destination communication carrier and a connection destination slice, based on a routing parameter, from among the predetermined communication carrier and the predetermined slice; and
a connection destination instruction means for notifying the connection destination communication carrier and the terminal of information on the connection destination communication carrier and the connection destination slice.

A use management system according to the present disclosure includes:
a plurality of terminals; and
a use management apparatus configured to manage each of a plurality of the terminals, wherein
the use management apparatus includes
an acquisition means for acquiring, from a user, a type of a service desired by the user using the terminal and a scheduled use time of the service, and acquiring a use condition of an application to be used when receiving the service, and a request condition for a communication carrier when receiving the service,
a connection destination determination means for selecting a predetermined communication carrier satisfying the use condition and the request condition from among a plurality of communication carriers, extracting a predetermined slice being available at the scheduled use time from among the predetermined communication carriers, and determining a connection destination communication carrier and a connection destination slice, based on a routing parameter, from among the predetermined communication carrier and the predetermined slice, and
a connection destination instruction means for notifying the connection destination communication carrier and the terminal of information on the connection destination communication carrier and the connection destination slice, and
each of a plurality of the terminals includes
a control acceptance means for accepting the connection destination communication carrier and the connection destination slice,
a routing means for generating a routing information table associating the connection destination slice, the service, and the application with one another,
a profile information storage means for storing profile information, based on the connection destination slice of the connection destination communication carrier, and
a connection destination selection means for connecting to the connection destination slice of the connection destination communication carrier in order to provide the service for the user, executing the application at the scheduled use time, and providing the service.

A method according to the present disclosure includes:
acquiring, from a user, a type of a service desired by the user using a terminal and a scheduled use time of the service;
acquiring a use condition of an application to be used when receiving the service, and a request condition for a communication carrier when receiving the service;
selecting a predetermined communication carrier satisfying the use condition and the request condition from among a plurality of communication carriers;
extracting a predetermined slice being available at the scheduled use time from among the predetermined communication carriers;
determining a connection destination communication carrier and a connection destination slice, based on a routing parameter, from among the predetermined communication carrier and the predetermined slice; and
notifying the connection destination communication carrier and the terminal of information on the connection destination communication carrier and the connection destination slice.

A non-transitory computer readable medium according to the present disclosure stores a program causing a computer to execute:
acquiring, from a user, a type of a service desired by the user using a terminal and a scheduled use time of the service;
acquiring a use condition of an application to be used when receiving the service, and a request condition for a communication carrier when receiving the service;
selecting a predetermined communication carrier satisfying the use condition and the request condition from among a plurality of communication carriers;
extracting a predetermined slice being available at the scheduled use time from among the predetermined communication carriers;
determining a connection destination communication carrier and a connection destination slice, based on a routing parameter, from among the predetermined communication carrier and the predetermined slice; and
notifying the connection destination communication carrier and the terminal of information on the connection destination communication carrier and the connection destination slice.

### Advantageous Effects of Invention

According to the present disclosure, it is possible to provide a use management apparatus, a use management system, a method, and a non-transitory computer readable medium that are capable of selecting an optimum connection destination communication carrier and an optimum connection destination slice, based on a request condition for a communication carrier, a use condition of an application, and the like.

### BRIEF DESCRIPTION OF DRAWINGS

FIG. 1 is a block diagram illustrating a use management apparatus according to a first example embodiment;

FIG. 2 is a block diagram illustrating a communication carrier and a slice;

FIG. 3 is a block diagram illustrating a use management system according to the first example embodiment;

FIG. 4 is a block diagram illustrating the use management system according to the first example embodiment;

FIG. 5 is a sequence diagram illustrating an operation of the use management system according to the first example embodiment;

FIG. 6 is a sequence diagram illustrating an operation of a connection destination slice instruction of the use management system according to the first example embodiment;

FIG. 7 is a diagram illustrating an operation of a terminal according to the first example embodiment;

FIG. 8 is a diagram illustrating a service definition, scheduled use information, and a template of a control command; and

FIG. 9 is a block diagram illustrating a system according to a comparative example of the first example embodiment.

### EXAMPLE EMBODIMENT

Hereinafter, example embodiments according to the present invention will be described with reference to the drawings. In each drawing, the same or corresponding elements are denoted by the same reference signs, and redundant descriptions are omitted as necessary for clarity of description.

### First Example Embodiment

### <Use Management Apparatus>

A configuration of a use management apparatus according to a first example embodiment will be described.

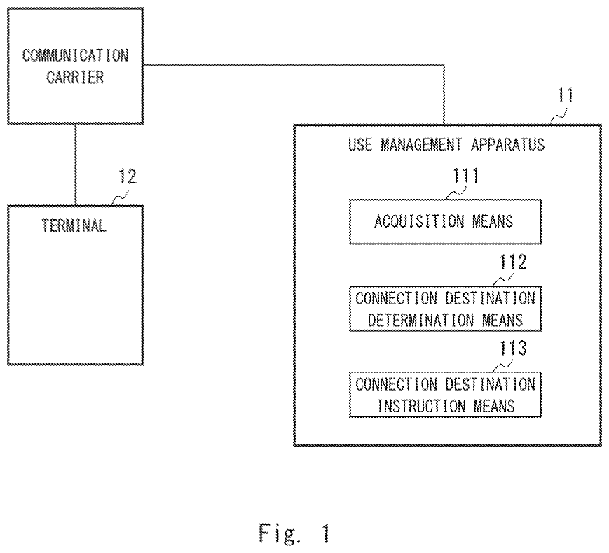

FIG. 1 is a block diagram illustrating the use management apparatus according to the first example embodiment.

As illustrated in FIG. 1, a use management apparatus 11 according to the first example embodiment includes an acquisition means 111, a connection destination determination means 112, and a connection destination instruction means 113. The use management apparatus 11 manages a scheduled use time of a user using a terminal 12 and preparation status of a slice (resource) of a communication carrier. The communication carrier may also be referred to as a wireless business operator, a communication business operator, or a telecommunication business operator.

The acquisition means 111 acquires, from a user, a type of a service desired by the user using the terminal 12, and a scheduled use time of the service. The terminal 12 is, for example, a drone or the like. The acquisition means 111 may acquire a service name instead of the type of the service. The acquisition means 111 acquires a use condition of an application to be used when receiving the service, and a request condition for a communication carrier when receiving the service. The acquisition means 111 registers and updates the scheduled use time of the terminal 12. In addition, the acquisition means 111 notifies the terminal 12 of use preparation completion notification indicating that a slice to be used is prepared. The request condition for the communication carrier is also specification of the communication carrier that a user desires for the communication carrier.

The connection destination determination means 112 selects a predetermined communication carrier satisfying the use condition and the request condition from among a plurality of communication carriers. The connection destination determination means 112 extracts a predetermined slice being available at the scheduled use time from among the predetermined communication carriers. The connection destination determination means 112 determines a connection destination communication carrier and a connection destination slice, based on a routing parameter, from among the predetermined communication carrier and the predetermined slice.

When data are transmitted from a transmission source to a destination, forwarding via an optimum route is referred to as routing. In this example, determining a connection destination communication carrier and a connection destination slice from among a plurality of slices of a plurality of communication carriers in order for the terminal 12 to provide a service is referred to as routing.

A network is divided (sliced), and the divided network is referred to as a network slice. The network slice may also be referred to as a slice. Each slice is used in order to provide a service according to application.

The connection destination instruction means 113 notifies the connection destination communication carrier and the terminal 12 of information on the connection destination communication carrier and the connection destination slice.

A routing parameter may include any of a communication cost of a communication carrier required in order to provide a service, a key performance indicator (KPI), and a delay time of the service.

A use condition of an application may include at least any of a data amount at a time of use of the application, a throughput at the time of use of the application, and a delay time at the time of use of the application.

A request condition for a communication carrier may include, for example, at least any of a use fee of a service, a throughput of the service, and a delay time of the service. A request condition for a communication carrier may be referred to as requirement specification.

Note that, a routing parameter is updated based on a request condition of a user for a communication carrier.

The use management apparatus 11 according to the first example embodiment selects a predetermined communication carrier satisfying a use condition of an application to be used when receiving a service, and a request condition (carrier specification) for a communication carrier when receiving a service, from among a plurality of communication carriers, extracts a predetermined slice being available at a scheduled use time from among the predetermined communication carriers, and determines a connection destination communication carrier and a connection destination slice, based on a routing parameter (a communication cost of a service, a KPI, a delay time of a service, and the like), from among the predetermined communication carrier and the predetermined slice.

In other words, the use management apparatus 11 changes a routing parameter (a communication cost or KPI used in routing), based on carrier specification desired by a user and a use condition of an application, and determines an optimum communication carrier and an optimum slice.

Accordingly, it is possible to provide a use management apparatus, a use management system, a method, and a non-transitory computer readable medium that are capable of selecting an optimum connection destination communication carrier and an optimum connection destination slice, based on a request condition for a communication carrier, a use condition of an application, and the like.

Herein, a more specific example will be described.

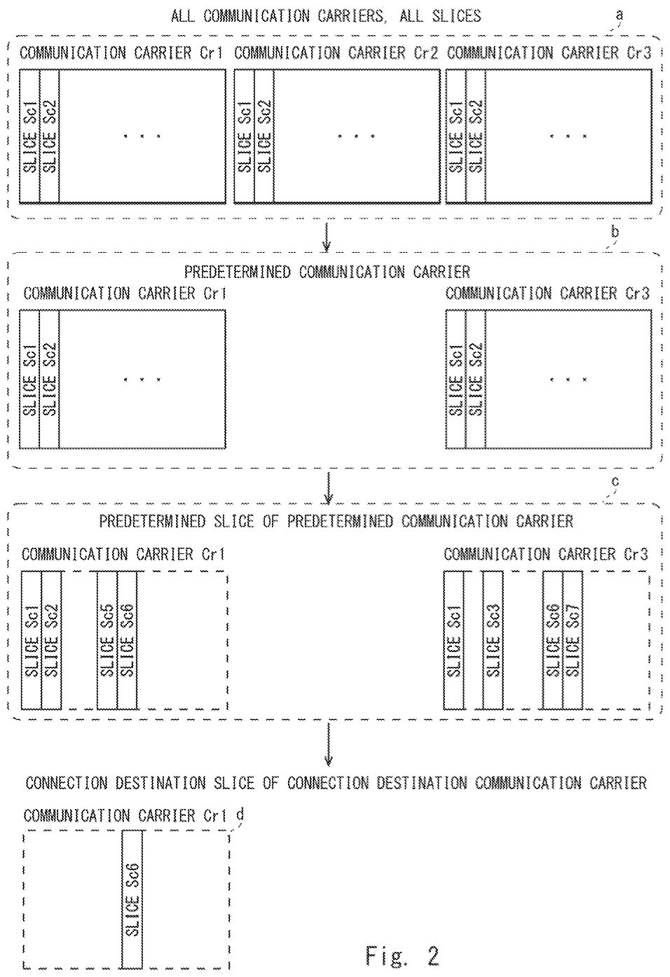

FIG. 2 is a block diagram illustrating a communication carrier and a slice.

The use management apparatus 11 acquires, from a user, a matter that a video service by using the terminal 12 such as a drone is requested, and information on a scheduled use time of the terminal 12.

The use management apparatus 11 acquires, from a user, a first condition of a capacity upper limit of 1 gigabyte/day as a use condition of an application to be used when receiving provision of the video service, and a second condition of an upper limit of 1500 yen/day as a request condition for a communication carrier.

As illustrated in FIG. 2, the use management apparatus 11 selects a predetermined communication carrier (a part b in FIG. 2) satisfying the first condition and the second condition from among all slices (a part a in FIG. 2) of all communication carriers.

The use management apparatus 11 extracts a predetermined slice (a part c in FIG. 2) being available at the scheduled use time from among the selected predetermined communication carriers.

The use management apparatus 11 selects a connection destination communication carrier and a connection destination slice (a part d in FIG. 2), based on a routing parameter, from among the predetermined communication carrier and the predetermined slice.

The use management apparatus 11 notifies the connection destination communication carrier and the terminal 12 of information on the connection destination communication carrier and the connection destination slice.

Herein, a case where the routing parameter is, for example, a lowest communication cost is considered. In this case, the one having the lowest communication cost is selected as the connection destination slice of the connection destination communication carrier.

In addition, when a communication carrier Cr1 is a mobile virtual network operator (MVNO) and there is an option such as using a RAN of a communication carrier Cr2 or a communication carrier Cr3 as a mobile network operator (MNO), a part of the RAN can be used by selecting the communication carrier Cr2 having a lower cost and a lower bandwidth.

In addition, when a user requests a broadband service, the communication carrier Cr3 being a broadband communication carrier can be selected and used.

Alternatively, a MVNO may be replaced with a private network such as local 5 generation (L5G) and private long term evolution (LTE).

### <Use Management System>

A configuration of a use management system according to the first example embodiment will be described.

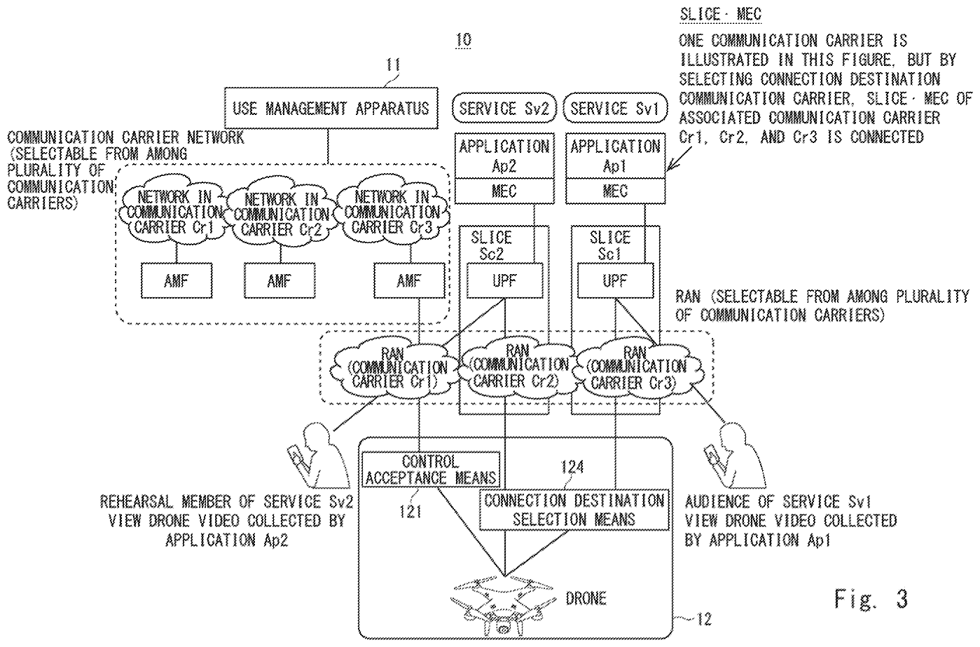

FIG. 3 is a block diagram illustrating the use management system according to the first example embodiment.

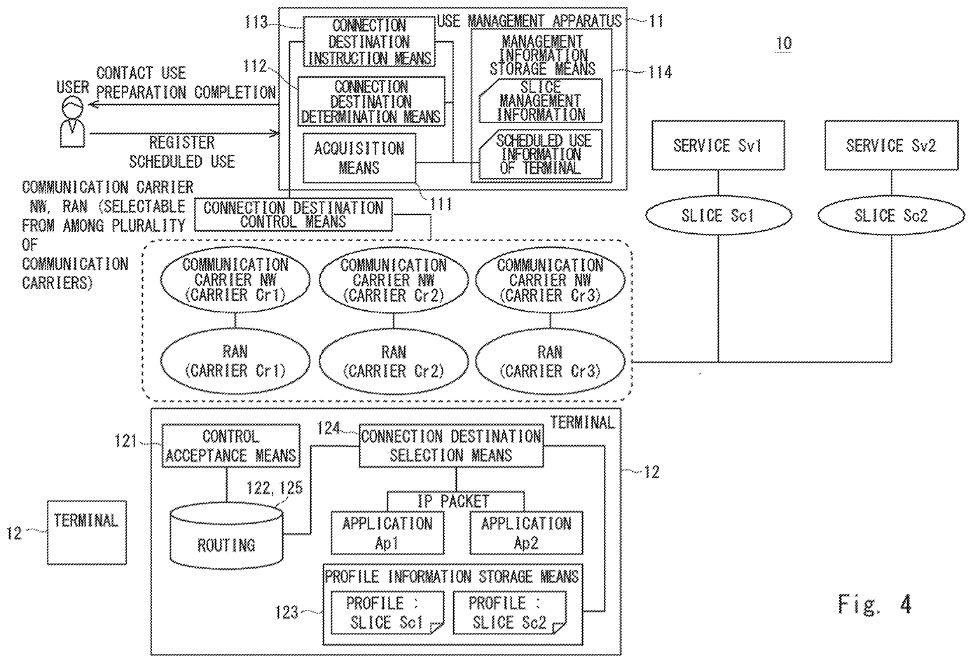

FIG. 4 is a block diagram illustrating the use management system according to the first example embodiment.

FIG. 4 illustrates a function of a use management apparatus and a terminal in comparison with FIG. 3.

In FIG. 3, the terminal 12 is illustrated as a drone, and the terminal 12 is connectable to a plurality of communication carriers.

As illustrated in FIGS. 3 and 4, a use management system 10 includes a plurality of the terminals 12, and the use management apparatus 11 that manages each of the plurality of terminals 12. The acquisition means 111, the connection destination determination means 112, and the connection destination instruction means 113 of the use management apparatus 11 have already been described, and thus description thereof will be omitted.

The use management system 10 includes a management information storage means 114 that stores slice management information and scheduled use information of the terminal 12. The slice management information is information indicating preparation status of a slice (resource) required for a communication carrier in order to provide a slice. The management information storage unit 114 acquires and stores information on the preparation status of the slice from the communication carrier. The scheduled use information of the terminal 12 is information about scheduled use of the terminal 12 being input from a user. The scheduled use information is a use date and time of the terminal 12, an application to be used, destination information, and the like, and is information for using the terminal 12. The destination information is information about a connection destination communication carrier and a connection destination slice.

### <Terminal>

Each of the plurality of terminals 12 includes a control acceptance means 121, a routing means 122, a profile information storage means 123, and a connection destination selection means 124. The terminal 12 is, for example, an apparatus of video equipment such as a drone.

The control acceptance means 121 accepts a connection destination communication carrier and a connection destination slice determined by the connection destination determination means 112. In other words, the control acceptance means 121 accepts a set instruction of the connection destination communication carrier and the connection destination slice from the use managing apparatus 11 being an external apparatus via a network (NW) included by a communication carrier.

The routing means 122 generates a routing information table associating a connection destination slice, a service, and an application with one another. The routing information is information for an application (an application Ap1 and an application Ap2) included in the terminal 12 to select a destination to which an internet protocol (IP) packet is to be transmitted. The destination to which the IP packet is to be transmitted indicates a connection destination communication carrier or a connection destination slice.

The profile information storage means 123 stores profile information, based on a connection destination slice of a connection destination communication carrier. The profile information storage means 123 updates (rewrites) the profile information when the connection destination communication carrier is changed or when the connection destination slice is changed.

The profile information is information stored in an embedded subscriber identity module (SIM), the terminal 12, or the like, and is information required for the terminal 12 to connect to a network of a communication carrier. The profile information needs to be stored in association with information on the connection destination slice used by the terminal 12. Therefore, the profile information storage means 123 stores the profile information and the connection destination slice in association with each other. The profile information may also be referred to as a profile.

The connection destination selection means 124 connects to a connection destination slice of a connection destination communication carrier in order to provide a service to a user. As a result, the terminal 12 can execute an application at a scheduled use time and provide the service to the user. In addition, the connection destination selection means 124 determines a destination to which the application performs IP packet communication.

The terminal 12 further includes a routing information storage means 125 that stores a routing information table.

### <Communication Carrier>

A communication carrier includes a connection destination control means. The connection destination control means accepts instruction information (information on the connection destination slice of the connection destination communication carrier) for the terminal 12 from the use management apparatus 11. The connection destination control means issues a control command to the terminal 12, based on the accepted instruction information, and updates setting information of the terminal 12.

A service Sv1 and a service Sv2 illustrated in FIGS. 3 and 4 each indicates a service provided by different users. The service Sv1 is arranged on a network associated to a slice Sc1, and the service Sv2 is arranged on a network associated to a slice Sc2. Both of the service Sv1 and the service Sv2 perform IP packet communication with the terminal 12 via a radio access network (RAN) or a core network of a communication carrier.

According to the first example embodiment, the terminal 12 connects to a mega carrier (in this example, the communication carrier Cr1) in case of requesting high-speed communication, according to needs of a user, and connects to a MVNO (in this example, the communication carrier Cr2) in case of requesting a low use fee. In this way, the terminal 12 can select a connection destination communication carrier.

### <System Operation>

An operation of the use management system according to the first example embodiment will be described.

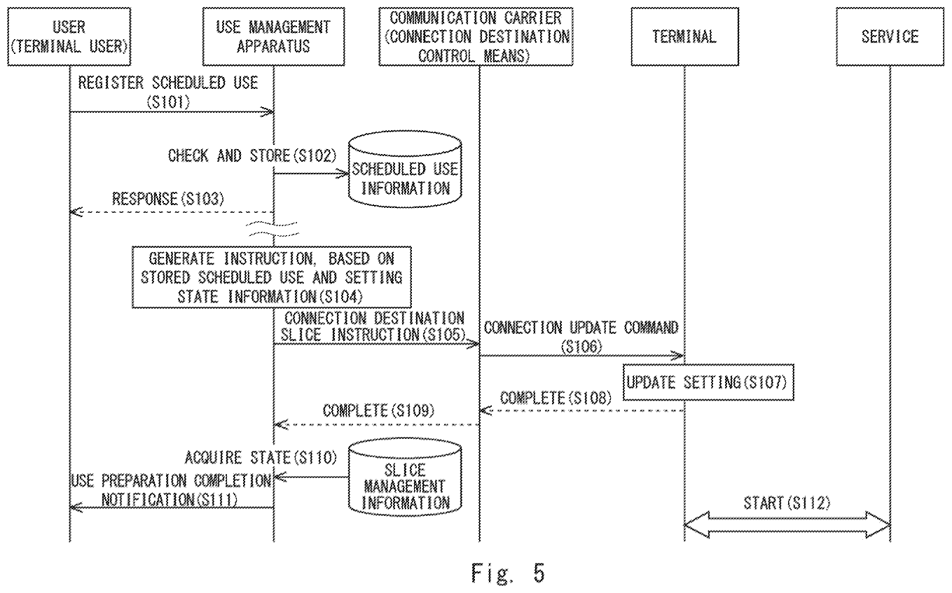

FIG. 5 is a sequence diagram illustrating an operation of the use management system according to the first example embodiment.

As illustrated in FIG. 5, a user using the terminal 12 registers a scheduled use of the terminal 12 in the use management apparatus 11 (step S101). The user may register information on a scheduled use date and time of the terminal 12, and may also register connection information such as an IP address or a URL of an application and information on a slice to be used.

The use management apparatus 11 performs duplication check (confirmation) in comparison with a scheduled use time of another user stored (held) in advance, based on a request from the user (information on the scheduled use date and time of the terminal 12, connection information of an application. Information on a slice to be used) (step S102). In other words, the use management apparatus 11 confirms whether a necessary slice (network resource) can be secured in the scheduled use time of the terminal 12 for the user. A slice may also be referred to as a network resource.

When a result of the confirmation is good and there is no problem (when there is no duplication), the use management apparatus 11 stores the scheduled use (step S102), and makes a response to the matter (step S103).

When a result of the confirmation is not good, the use management apparatus 11 cannot satisfy a use condition required by the user, and therefore does not perform an update instruction (step S106 to be described later) of profile information and routing information toward the terminal 12. In addition, the use management apparatus 11 does not perform use preparation completion notification (step S111 to be described later).

The use management apparatus 11 asynchronously performs an instruction toward the terminal 12. The use management apparatus 11 generates an instruction, based on a stored scheduled use of the plurality of terminals 12 and setting state information of the terminal 12 (step S104). The setting state information is information including at least a use condition of an application, a request condition for a communication carrier, a scheduled use time of a service, and a routing parameter.

The use management apparatus 11 performs an instruction of a connection destination slice on the connection destination control means of a communication carrier (connection destination communication carrier) (step S105). Instead of the instruction of the connection destination slice, an instruction of a connection destination network including the connection destination slice may be performed.

The connection destination control means of the communication carrier receives the instruction of the connection destination communication carrier and the connection destination slice, and issues a connection update command to the terminal 12 (step S106). The connection update command may also be referred to as a control command. For the control command to the terminal 12, another communication means different from a communication means used for connecting to the connection destination slice may be used. For example, a short message service (SMS) may be used.

The terminal 12 receives the connection update command, and updates the setting information of the terminal 12 according to a content of the connection update command (step S107).

The terminal 12 notifies the connection destination control means that the update of the setting information is completed (step S108). The use management apparatus 11 notifies the use management apparatus 11 that the update of the setting information of the terminal 12 is completed (step S109).

The use management apparatus 11 acquires, from slice management information, notification that a preparation state of the slice is completed (step S110).

The use management apparatus 11 sends the use preparation completion notification to the user by a fact that a connection destination slice instruction (update of the setting information) to the terminal 12 is completed (step S109) and a fact that the preparation state of the slice acquired from the slice management information is completed (step S110) (step S111).

As a result, the user can recognize that the service desired by the user is started via the terminal 12 (step S112) and the service is available.

The use management apparatus 11 selects a predetermined communication carrier satisfying a use condition of an application to be used when receiving a service and a request condition (carrier specification) for a communication carrier when receiving the service from among a plurality of communication carriers, extracts a predetermined slice being available at a scheduled use time from among the predetermined communication carriers, and determines a connection destination communication carrier and a connection destination slice, based on a routing parameter (a communication cost of a service, a KPI, a delay time of a service, and the like), from among the predetermined communication carrier and the predetermined slice.

Accordingly, the routing parameter (a communication cost and a KPI used in routing) can be changed based on the carrier specification desired by a user and the use condition of the application. As a result, as a first advantageous effect, it is possible to acquire a use management apparatus or the like capable of selecting an optimum connection destination communication carrier and an optimum connection destination slice, based on the request condition for the communication carrier, the use condition of the application, and the routing parameter.

In addition, according to the first example embodiment, when a terminal is connectable to a plurality of communication carriers (including a MVNO) and a scheduled use time of the terminal fluctuates, a connection destination can be switched to an optimum communication carrier and an optimum slice according to needs of the scheduled use time.

As a result, the use management apparatus can adjust to a service desired by a user and a scheduled use time thereof, and therefore, as a second advantageous effect, it is possible to select a mega communication carrier as a connection destination communication carrier in a case of a service requiring high-speed communication, and it is possible to select a MVNO in a case where a low use fee is required. In this way, an optimum destination communication carrier can be selected.

In addition, as a third advantageous effect, the use management apparatus can automatically change connection destination slice information (a connection destination slice or destination routing) of a terminal in consideration of a scheduled use of the terminal. The reason is because the use management apparatus grasps the scheduled use of the terminal of a user and instructs the terminal to remotely change connection information.

In addition, as a fourth advantageous effect, a user can grasp preparation status of a resource (slice) of a network of a terminal and a communication carrier associated to the terminal. The reason is because the use management apparatus can grasp not only information on the connection destination slice of the terminal but also the preparation status of the network resource of the communication carrier, and therefore notifies the user of the information.

### <Indication Operation>

An operation of a connection destination slice instruction of the use management system according to the first example embodiment will be described in detail.

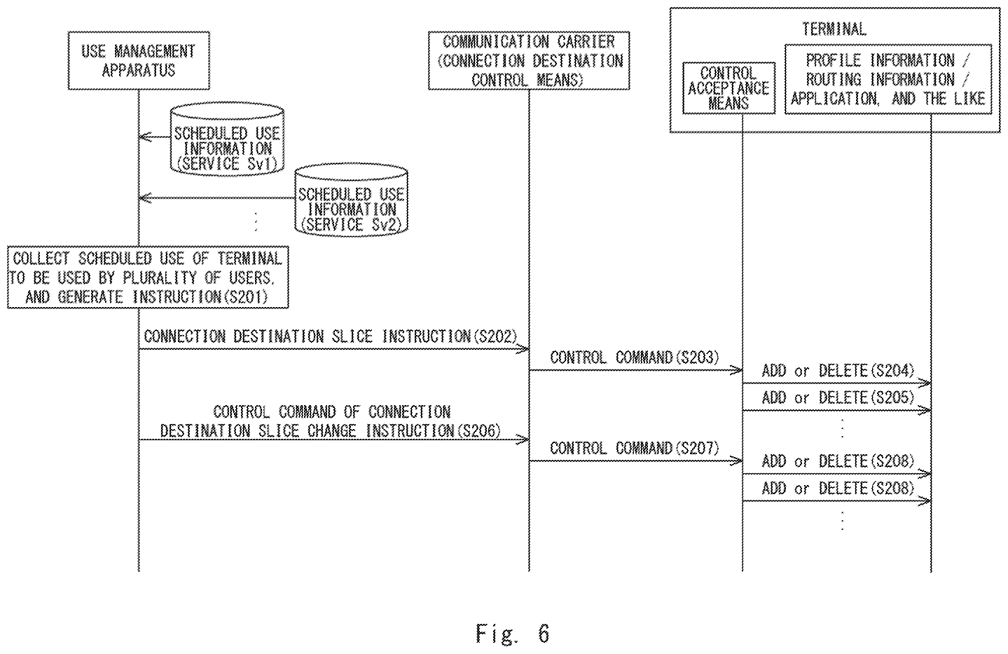

FIG. 6 is a sequence diagram illustrating an operation of the connection destination slice instruction of the use management system according to the first example embodiment.

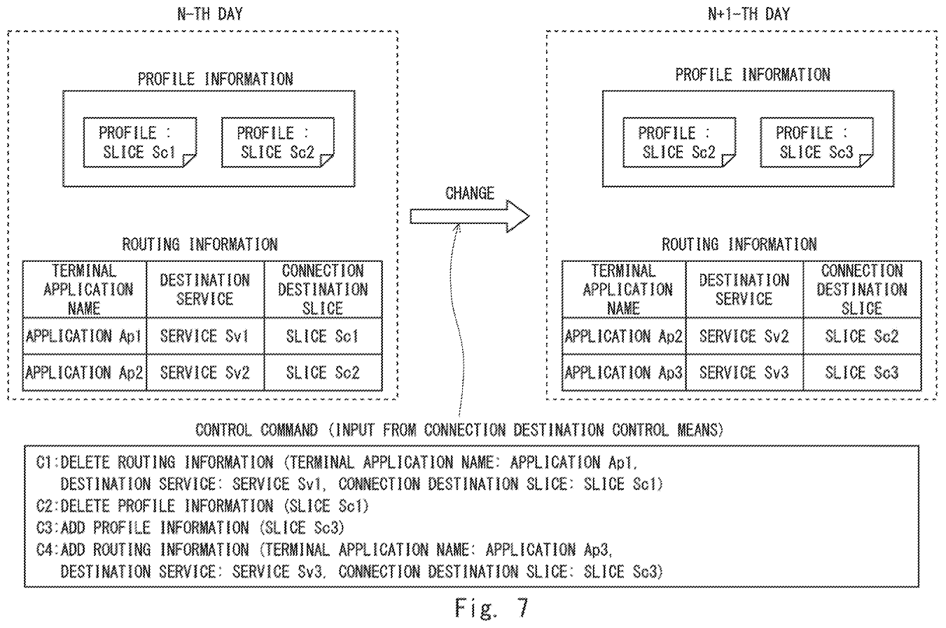

FIG. 7 is a diagram illustrating an operation of a terminal according to the first example embodiment.

In FIG. 7, an operation in which profile information stored in the profile information storage unit 123 of the terminal 12 and routing information stored in the routing information storage unit 125 of the terminal 12 are updated is illustrated.

As illustrated in FIGS. 6 and 7, on an N-th day (N is any integer), the use management apparatus 11 acquires the service Sv1 desired by a user U1 and a scheduled use time thereof, and the service Sv2 desired by a user U2 and a scheduled use time thereof, collects the scheduled use of the terminal 12 of the users, and thereby generates an instruction of a connection destination slice (step S201). The use management apparatus 11 notifies the connection destination control means of a communication carrier of the instruction of the generated connection destination slice (step S202).

The terminal 12 acquires a control command from the use management apparatus 11 in advance according to a request from the user U1 (step S203), and registers routing information in such a way as to perform communication between the application Ap1 and the service Sv1 (step S204). In addition, the terminal 12 specifies the slice Sc1 as the connection destination slice to be connected (step S204).

Similarly, the terminal 12 registers routing information in such a way as to perform communication between the application Ap2 and the service Sv2 according to a request from the user U2, and specifies the slice Sc2 as the connection destination slice to be connected (step S205).

On an N+1-th day, the user U2 is scheduled to continue using the terminal 12, the user U1 is scheduled not to use the terminal 12, and a user U3 is scheduled to newly start using the terminal 12. Therefore, the terminal 12 needs to register routing information in such a way as to perform communication between an application Ap3 and a service Sv3 according to a request from the user U3, and specify a slice Sc3 as the connection destination slice to be connected.

Therefore, toward the N+1-th day, the use management apparatus 11 instructs a change of a setting state on the N-th day and the N+1-th day by a control command (step S206). Specifically, the use management apparatus 11 instructs the terminal 12 by a control command C1 to a control command C3 illustrated in FIG. 7.

The connection destination control means of the communication carrier receives the instruction, and issues a control command to the terminal 12 (step S207).

The control acceptance unit 121 of the terminal 12 receives the control command from the connection destination control means, and adds or deletes the profile information, the routing information, the application, and the like according to the control command (step S208).

### <Generation Procedure of Control Command>

A generation procedure of a control command instructed by the use management apparatus 11 will be described.

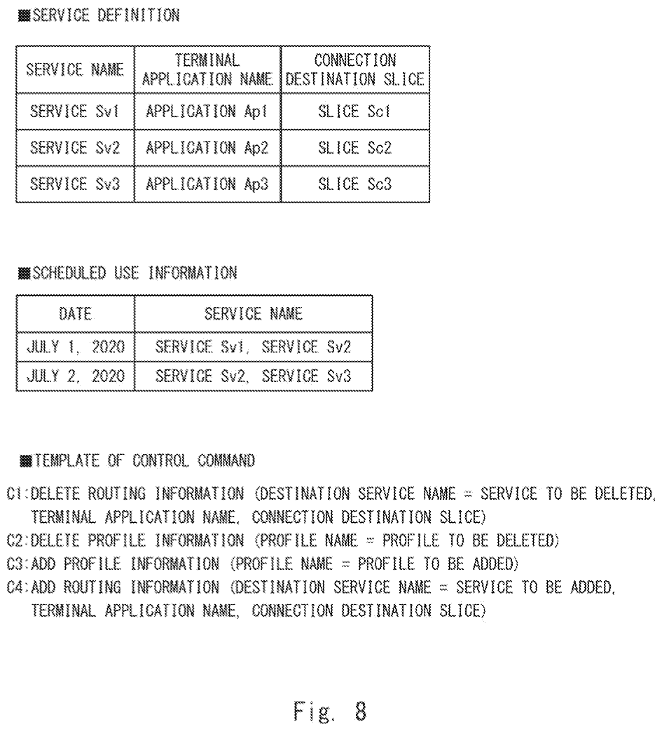

FIG. 8 is a diagram illustrating a service definition, scheduled use information, and a template of a control command.

The use management apparatus 11 holds the service definition, the scheduled use information, and the template of the control command illustrated in FIG. 8.

The service definition defines a relationship among a service name, and a terminal application name and a connection destination slice associated with the service name. The connection destination slice indicates a slice to be connected by the terminal 12, and may be expressed as an access point name (APN).

The scheduled use information indicates a service name to be used by connecting the terminal 12 in units of dates, based on the scheduled use of the terminal 12 being input by a user. In this example, the service Sv1 and the service Sv2 are shared and used on Jul. 1, 2020, and the service Sv2 and the service Sv3 are shared and used on Jul. 2, 2020.

The template of the control command indicates four instruction contents as a pattern of the control command for instructing the terminal 12. In this example, a procedure for performing setting update of the terminal 12 from Jul. 1, 2020 to Jul. 2, 2020 is as follows.

Procedure 1: Compare a change in scheduled use information from Jul. 1, 2020 to Jul. 2, 2020. As a result, an instruction that the service Sv1 is deleted, the service Sv2 is not changed, and the service Sv3 is newly added is generated in a procedure 2.

Procedure 2: Generate the following instruction 1 and instruction 2 for a target to be deleted.

Instruction 1 (delete routing information): Confirm the template of the control command, and generate a control command by using a control command C1: delete routing information template. Further, a service name equivalent to a destination service name (the service Sv1 in this example) is set, and a terminal application name (the application Ap1 in this example) and a connection destination slice (the slice Sc1 in this example) related to the service Sv1 are acquired from a service definition table and are set to the control command.

Instruction 2 (delete profile information): Confirm the template of the control command, and generate a control command by using a control command C2: delete profile information template. Further, the connection destination slice (the slice Sc1 in this example) associated with the service name equivalent to the destination service name (the service Sv1 in this example) is acquired from the service definition table, and is set to a profile name of the control command.

Procedure 3: Generate the following instruction 3 and instruction 4 for a target to be added.

Instruction 3 (add profile information): Confirm the template of the control command, and generate a control command by using a control command C3: add profile information template. Further, the connection destination slice (the slice Sc3 in this example) associated with the service name equivalent to the destination service name (the service Sv3 in this example) is acquired from the service definition table, and is set to the profile name of the control command.

Instruction 4 (add routing information): Confirm the template of the control command, and generate a control command by using a control command C4: add routing information template. Further, a service name equivalent to the destination service name (the service Sv3 in this example) is set, and a terminal application name (the application Ap3 in this example) and a connection destination slice (the slice Sc3 in this example) related to the service Sv3 are acquired from the service definition table and are set to the control command.

Procedure 4: The control commands generated from the procedures 1 to 3 are collectively instructed to the connection destination control means of the communication carrier in generated order.

Herein, a characteristic of the first example embodiment will be described.

A predetermined communication carrier satisfying a use condition of an application used by a user and a request condition for a communication carrier is selected, a predetermined slice being available at a scheduled use time is extracted from among the predetermined communication carriers, and a connection destination communication carrier and a connection destination slice are determined based on a routing parameter.

### Comparative Example

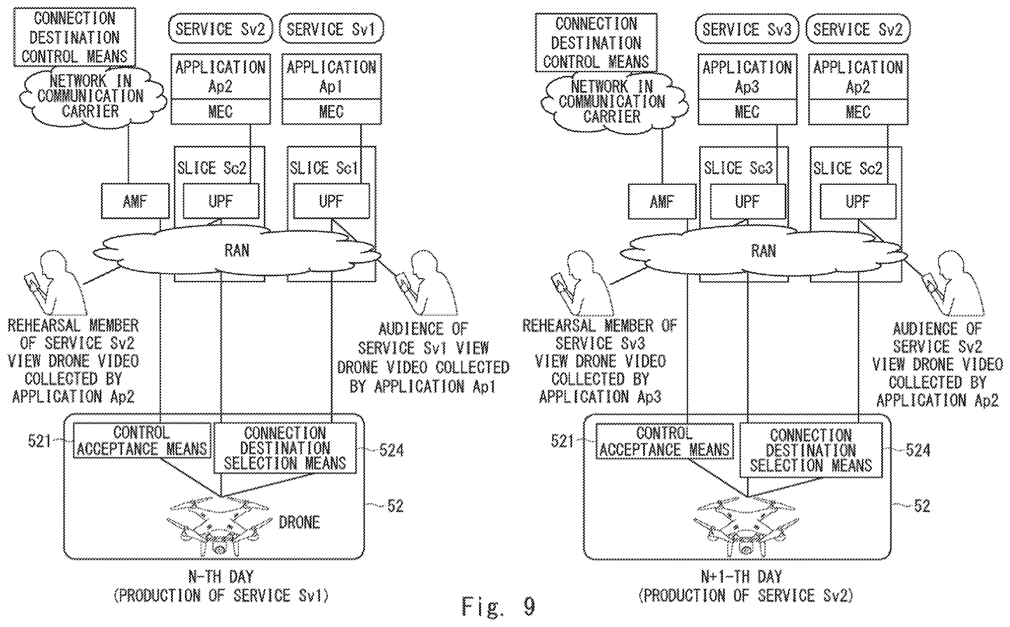

FIG. 9 is a block diagram illustrating a system according to a comparative example of the first example embodiment.

As illustrated in FIG. 9, in the system according to the comparative example, there is a mechanism for rewriting profile information of a communication carrier remotely to an embedded SIM. The mechanism makes it possible, for example, when a SIM-equipped terminal (or a SIM-equipped vehicle) is exported from an assembling country and sold overseas, to write profile information of a communication carrier that can be selected in the country to the SIM at a time of purchase. However, when this technique is applied to a use case using a slice in a 5G network, for example, the following disadvantages arise.

In 5G slice technology, a network to which a SIM-equipped terminal equipped with a SIM is connected can be independently connected to a plurality of slices in units of slices. Then, an application in the terminal needs to select a slice of a network to be used for communication.

For example, a case where a terminal 52 (a drone in the drawing) including a configuration as illustrated in FIG. 9 is connected to a plurality of slices (two slices in the drawing) will be considered. In this example, it is assumed that data such as a video captured by a drone are simultaneously handled as two types of use cases. In addition, it is assumed that a plurality of users share and use one terminal 52, for example, the drone is installed in a facility such as a stadium.

On an N-th day, a service Sv1 distributes data, such as a video of drone capturing, to an audience of the service Sv1 as a production service. The service Sv1 is a service in which captured data of a drone are converted into a video content in real time by an application Ap1 and delivered to an audience. In such a case, the application can be arranged in multi-access edge computing (MEC) of a 5G network, and a service such as augmented reality (AR) can be provided by processing a captured video with a low delay.

A service Sv2 schedules a production service on an N+1-th day, and distributes data, such as a video of the drone capturing, to a rehearsal member of the service Sv2 for a limited purpose such as rehearsal on the N-th day being a previous day. The service Sv2 on the N-th day arranges an application Ap2 on a different MEC from the application Ap1, and also a different slice from that of the service Sv1 is used. On the production day (N+1-th day), the service can be enjoyed when the audience of the service Sv2 connects to the same slice by using the environment as it is. At this time, enabling the audience of the service Sv2 to be connected to a slice Sc2 is achieved by a mechanism of a mobile carrier.

In the comparative example, it is not possible to externally control a slice or a destination routing used by the terminal 52, based on a scheduled use of a user of the terminal 52. In addition, it is not possible to control a connection destination slice based on preparation status of a network resource such as a slice of a network of a communication carrier, and to notify a user of the status.

Accordingly, in the comparative example, it is difficult to provide a use management apparatus, a use management system, a method, and a non-transitory computer readable medium that are capable of selecting an optimum connection destination communication carrier and an optimum connection destination slice, based on a request condition for a communication carrier, a use condition of an application, and the like.

### Second Example Embodiment

In a second example embodiment, a terminal used by a user is an unmanned ground vehicle (UGV). An application in the terminal handles information such as a position of the UGV and an in-vehicle camera video, and provides a service by secondary using the information. The service to be provided is associated with, for example, a service Sv1, a service Sv2, and a service Sv3 illustrated in the first example embodiment.

Specifically, the second example embodiment can be applied to the following services.

A service for analyzing public transportation information.

A service for storing a captured moving image when an accident occurs, for example, in order to prove the accident in insurance.

A collection and delivery service for a predetermined company.

In particular, the collection and delivery service may be such that the same UGV delivers packages collected from several separate companies. In such a case, a plurality of companies share and use one UGV. In other words, since the service exists separately for each company, it is necessary to separately control routing in the terminal UGV. Therefore, for example, when the UGV is located at a base of a company X, the company X is routed with a video and position information. On the other hand, only location information is routed to a company Y.

Note that, although the present invention has been described as a hardware configuration in the above-described example embodiments, the present invention is not limited thereto. The present invention can also be achieved by causing a central processing unit (CPU) to execute a computer program.

In the above example embodiments, a program can be stored by using various types of non-transitory computer readable media, and supplied to a computer. A non-transitory computer readable medium includes various types of tangible storage media. Examples of the non-transitory computer readable medium include a magnetic recording medium (specifically, a flexible disk, a magnetic tape, or a hard disk drive), a magneto-optical recording medium (specifically, a magneto-optical disk), a CD-read only memory (ROM), a CD-R, a CD-R/W, a semiconductor memory (specifically, a mask ROM, a programmable ROM (RPOM), and an erasable PROM (EPROM)), a flash ROM, and a random access memory (RAM). In addition, the program may also be supplied to the computer by various types of transitory computer readable media. Examples of the transitory computer readable medium includes an electric signal, an optical signal, and an electromagnetic wave. The transitory computer readable medium can supply the program to the computer via a wired communication path such as an electric wire and an optical fiber, or a wireless communication path.

Although the invention of the present application has been described with reference to the example embodiments, the invention of the present application is not limited to the above. Various modifications that can be understood by a person skilled in the art can be made to the configuration and details of the invention of the present application within the scope of the invention.

Note that, the present invention is not limited to the above-described example embodiments, and can be appropriately modified without departing from the spirit thereof.

### REFERENCE SIGNS LIST

10 USE MANAGEMENT SYSTEM
11 USE MANAGEMENT APPARATUS
111 ACQUISITION MEANS
112 CONNECTION DESTINATION DETERMINATION MEANS
113 CONNECTION DESTINATION INSTRUCTION MEANS
12, 52 TERMINAL
121, 521 CONTROL ACCEPTANCE MEANS
122 ROUTING MEANS
123 PROFILE INFORMATION STORAGE MEANS
124, 524 CONNECTION DESTINATION SELECTION MEANS
125 ROUTING INFORMATION STORAGE MEANS
Ap1, Ap2, Ap3 APPLICATION
Sc1, Sc2, Sc3 SLICE
Sv1, Sv2, Sv3 SERVICE
U1, U2 USER

What is claimed is:

1. A use management apparatus comprising:
acquisition means for acquiring, from a user, a type of a service desired by the user using a terminal and a scheduled use time of the service, and acquiring a use condition of an application to be used when receiving the service, and a request condition for a communication carrier when receiving the service;
connection destination determination means for selecting a predetermined communication carrier satisfying the use condition and the request condition from among a plurality of communication carriers, extracting a predetermined slice being available at the scheduled use time from among the predetermined communication carriers, and determining a connection destination communication carrier and a connection destination slice, based on a routing parameter, from among the predetermined communication carrier and the predetermined slice; and
connection destination instruction means for notifying the connection destination communication carrier and the terminal of information on the connection destination communication carrier and the connection destination slice.

2. The use management apparatus according to claim 1, wherein the routing parameter includes any of a communication cost of the communication carrier being required in order to provide the service, a key performance indicator (KPI), and a delay time of the service.

3. The use management apparatus according to claim 1, wherein a use condition of the application includes at least any of a data amount at a time of use of the application, a throughput at the time of use of the application, and a delay time at the time of use of the application.

4. The use management apparatus according to claim 1, wherein a request condition for the communication carrier includes at least any of a use fee of the service, a throughput of the service, and a delay time of the service.

5. The use management apparatus according to claim 1, wherein the routing parameter is updated based on a request condition of the user for the communication carrier.

6. A use management system comprising:
a plurality of terminals; and
a use management apparatus configured to manage each of a plurality of the terminals, wherein
the use management apparatus includes
acquisition means for acquiring, from a user, a type of a service desired by the user using the terminal and a scheduled use time of the service, and acquiring a use condition of an application to be used when receiving the service, and a request condition for a communication carrier when receiving the service,
connection destination determination means for selecting a predetermined communication carrier satisfying the use condition and the request condition from among a plurality of communication carriers, extracting a predetermined slice being available at the scheduled use time from among the predetermined communication carriers, and determining a connection destination communication carrier and a connection destination slice, based on a routing parameter, from among the predetermined communication carrier and the predetermined slice, and
connection destination instruction means for notifying the connection destination communication carrier and the terminal of information on the connection destination communication carrier and the connection destination slice, and
each of a plurality of the terminals includes
control acceptance means for accepting the connection destination communication carrier and the connection destination slice,
routing means for generating a routing information table associating the connection destination slice, the service, and the application with one another,
profile information storage means for storing profile information, based on the connection destination slice of the connection destination communication carrier, and
connection destination selection means for connecting to the connection destination slice of the connection destination communication carrier in order to provide the service for the user, executing the application at the scheduled use time, and providing the service.

7. The use management system according to claim 6, wherein the terminal further includes routing information storage means for storing the routing information table.

8. A method comprising:
acquiring, from a user, a type of a service desired by the user using a terminal and a scheduled use time of the service;
acquiring a use condition of an application to be used when receiving the service, and a request condition for a communication carrier when receiving the service;
selecting a predetermined communication carrier satisfying the use condition and the request condition from among a plurality of communication carriers;
extracting a predetermined slice being available at the scheduled use time from among the predetermined communication carriers;
determining a connection destination communication carrier and a connection destination slice, based on a routing parameter, from among the predetermined communication carrier and the predetermined slice; and
notifying the connection destination communication carrier and the terminal of information on the connection destination communication carrier and the connection destination slice.

9. (canceled)
